(19) United States
(12) Patent Application Publication
(10) Pub. No.: US 2021/0365674 A1
(43) Pub. Date: Nov. 25, 2021

(54) SYSTEM AND METHOD FOR SMART MONITORING OF HUMAN BEHAVIOR AND ANOMALY DETECTION

(71) Applicant: Cherry Labs, Inc., Wilmington, DE (US)

(72) Inventors: Stanislav Veretennikov, San Francisco, CA (US); Vladimir Baskakov, Moscow (RU); Anton Maltsev, Moscow (RU); Margarita Goncharova, Redwood City, CA (US); Maksim Goncharov, Redwood City, CA (US)

(21) Appl. No.: 17/393,049

(22) Filed: Aug. 3, 2021

Related U.S. Application Data
(63) Continuation of application No. PCT/US21/24328, filed on Mar. 26, 2021.
(60) Provisional application No. 63/001,820, filed on Mar. 30, 2020.

(51) Int. Cl. G06K 9/00; G06N 20/00; G06N 5/04; G06T 7/73

(52) U.S. Cl. CPC G06K 9/00335; G06N 20/00; G06N 5/04; G06T 7/74; G06T 2207/30232; G06T 2207/30196; G06T 2207/20081; G06T 2207/10016; G06T 2207/20084; G06K 9/00771

(57) ABSTRACT

A new approach is proposed that contemplates systems and methods to monitor the premises, e.g., home, office facility, manufacturing floor, healthcare facility, nursing home, etc., to detect an abnormal activity, e.g., fire, smoke, flood, intrusion, fall, stroke, etc., in a smart fashion by leveraging machine learning (ML) model. The method includes receiving a data stream from an input device at a monitored location. The data stream is processed to determine a pose and a position of a person at the monitored location. It is determined whether an abnormal activity has occurred based on the pose and the position of the person. A message is transmitted to a user in response to the determining.

### CROSS-REFERENCE TO RELATED APPLICATIONS

This application is a continuation application of United States Patent Application No. PCT/US21/24328, filed Mar. 26, 2021, entitled “System and Method for Efficient Machine Learning Model Training,” which claims the benefit of U.S. Provisional Patent Application No. 63/001,820, filed Mar. 30, 2020. Both of which are incorporated herein in their entireties by reference.

### BACKGROUND

A variety of security, monitoring and control systems equipped with a plurality of cameras and/or sensors have been used to detect various threats such as health threats (e.g., falling, fainting, becoming unconscious and unresponsive, etc.) as well as security threats such as intrusions, or even natural disaster threats such as fire, smoke, flood, etc. For a non-limiting example, motion detection is often used to detect intruders in vacated homes or buildings, wherein the detection of an intruder may lead to an audio or silent alarm and contact of security personnel. Video monitoring is also used to provide additional information about personnel living in an assisted living facility but unfortunately it is labor intensive.

Currently, the monitoring and control systems may detect health threats via manual activation of an alarm by the person experiencing the threat, e.g., an elderly person activating a button when a fall is experienced, etc., or by a healthcare professional actively watching and monitoring the elderly person, which can be labor intensive. In some conventional systems an intrusion to the premises is detected using various sensors, e.g., motion sensor, smoke detector, etc. Conventional security systems such as alarm systems while may be automatic, they often fall short of intelligently detecting certain abnormal activity, e.g., intrusion to the premises if the alarm is not activated, someone being held at gun point, etc. In some case, health monitoring systems may also fall short of detecting a health threat when an individual experiences stroke by noticing changes in behavior, etc., for a non-limiting example. As such, many disasters that are time sensitive are unnecessarily prolonged before appropriate help can be dispatched.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C depict an application example of a monitoring system in accordance with some embodiments.

FIGS. 2A-2B depict an application example of a system detecting an abnormal activity in accordance with some embodiments.

FIG. 3 depicts an application example of a monitoring system rendering events in accordance with some embodiments.

FIGS. 4A-4C depicts an application example of selecting a portion of the captured data to be transmitted for further analysis or for alerting an individual in accordance with some embodiments.

FIG. 5 depicts a block diagram of a monitoring system in accordance with some embodiments.

FIG. 6 depicts relational node diagram depicting an example of a neural network for identifying an abnormal activity in accordance with some embodiments.

FIG. 7 depicts a flow chart illustrating an example of method flow for determining an abnormal activity in accordance with some embodiments.

FIG. 8 depicts a block diagram depicting an example of computer system suitable for determining an abnormal activity in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to monitor premises, e.g., home, office facility, manufacturing floor, healthcare facility, nursing home, etc., to detect an abnormal activities at the premises, e.g., fire, smoke, flood, intrusion, fall, stroke, etc., in a smart fashion by leveraging machine learning (ML) model. In some embodiments, the ML model may either be trained under supervision via provided training data or be trained without supervision and over time by analyzing the behaviors and patterns within the monitored premises.

In some embodiments, a monitoring system uses an input data from a captured device, e.g., camera, microphone, infrared, etc., and processes the captured data to determine whether an abnormal activity has occurred. In some embodiments, the captured data may be processed to generate a modified data, e.g., the individuals in the captured video data may be pixelated for privacy reasons or as 2-dimensional (2D) images (e.g., skeletons) of a person (e.g., human body), etc. It is appreciated that the captured data or modification thereof may be used to determine the individual's pose, position, orientation, height position, etc., which are critical in identifying the person's ordinary/normal activities at the monitored location. It is appreciated that in some embodiments, the captured data or a modified version thereof, e.g., 2D images of a person, etc., may be stored in a storage medium, e.g., hard drive, solid state drive, etc. It is appreciated that replacing an individual in the image with a 2D image may significantly reduce the processing needs of the system, e.g., less processing resources may be needed, processing speed may be increased, etc.

In some embodiments, the captured data and/or modified version thereof may be processed to determine whether an abnormal activity has occurred. In some embodiments, a ML model that may include a neural network model for clustering, grouping, etc., may be applied to the captured data in order to determine whether an abnormal activity has occurred. In other words, in some embodiments, the determined pose, position, orientation, etc., associated with an individual may be compared to the training data (either supervised or unsupervised or semi-supervised) of the ML model. In some embodiments, the ML model may use various clustering or grouping methods to determine whether the determined pose, position, orientation, etc., is consistent with normal activity (of the person captured at the monitored location or other persons possibly at other locations). If it is determined that the behavior is abnormal (i.e. inconsistent with past behavior or inconsistent with other individuals) then an alert, e.g., a message, etc. may be generated and sent. It is appreciated that inconsistent past behavior may have a time dimension and/or location dimension associated therewith. For example, a behavior that may be flagged as normal if it occurs during the day may be flagged as abnormal if it occurs at 3 a.m. Similarly, being on the floor in a room where a person routinely exercise in may be deemed normal whereas being on the floor in the kitchen may be flagged as abnormal and indicative that the person may have fallen. It is appreciated that an abnormal behavior or event may be determined based on series of poses, positions, orientations, body configurations, etc. It is appreciated that in some non-limiting examples, when a home monitoring system determines that there is home invasion the police may be alerted, whereas in a senior home facility a nurse may be notified and yet in a hospital setting a doctor may be notified.

It is appreciated that while most embodiments are described with respect to images within the video data stream, the embodiments are not limited thereto. For a non-limiting example, audio data stream may similarly be processed to determine whether an abnormal even has occurred. Specifically, in some embodiments an audio data stream once analyzed may determine that someone has fallen or that a window has been broken or that someone is screaming for help. In some nonlimiting examples, a natural language processing (NLP) may be used for audio analysis. Moreover, in some embodiments, voice recognition may be used to identify the individuals present at the premises and if an individual is not recognized (e.g., by never being at the premises) or if other cues indicate, (e.g., shattered glass, video footage of someone holding a gun, or “help, help” etc.) then it may be determined that an abnormal activity such as home invasion has occurred.

It is appreciated that the ML model may be trained based on other individuals from other premises and/or based on collecting data over time from the monitored premises. For example, the ML model functions differently on a premises with a toddler that falling is a regular occurrence than premises without one or with seniors. Once trained, the one or more ML models are applied by the monitoring system to filter one or more video/audio data streams of captured daily activities at the monitored location and to alert an administrator/operator or other users such as family member, if an abnormal activity is recognized and detected from the video streams captured at the monitored location based on the trained one or more ML models of the person's normal activity. It is appreciated that the ML model may be modified over time as the behavior of the individuals at the monitored premises change. In other words, the monitoring system tracks the short term as well as long term behavioral trends within the monitored location by monitoring changes. In some examples, the manner of which the ML model behaves changes as the monitored location, e.g., individuals at the monitored location, change. For example, in some embodiments, the ML model may behave differently before an individual at a monitored location has a stroke and after because the facial features, the pose, the orientation, the way the body moves, the positioning of the individual, the height of the individual (e.g., if now wheelchair bound), etc., changes.

When applied specifically to a non-limiting example of home monitoring pertinent to elderly care, the proposed approach enables all normal routine activities/actions/behaviors of the elders to be quickly learned by the ML models in order to ascertain the daily normal behavior, which will be tagged accordingly. Although the daily normal activities are usually immensely complex to learn, analyze and predict, the proposed approach is able to drastically reduce the time it takes to train and deploy the ML model for a neural network from a captured video stream. As such, when integrated into a security monitoring system, the trained ML models can effectively and efficiently detect subtle abnormal trends in the daily activities of the elders such as a person is walking slower, starting to limp over a period of time (e.g., 6 to 12 months), waking up more frequently during the night, etc. In some embodiments, the ML models can be quickly trained to detect certain types of activities or actions that are specific to a particular person, like falling, coughing, distress, etc. It is appreciated that the embodiments are described with respect to a facility with elderly care for illustrative purposes but the embodiments are not limited thereto. For example, the system is applicable to other settings, e.g., residential homes, office building, warehouses, penitentiary, hospital, etc., to name a few.

Although security monitoring systems have been used as non-limiting examples to illustrate the proposed approach to efficient ML model training, it is appreciated that the same or similar approach can also be applied to efficiently train and validate ML models used in other types of AI-driven systems.

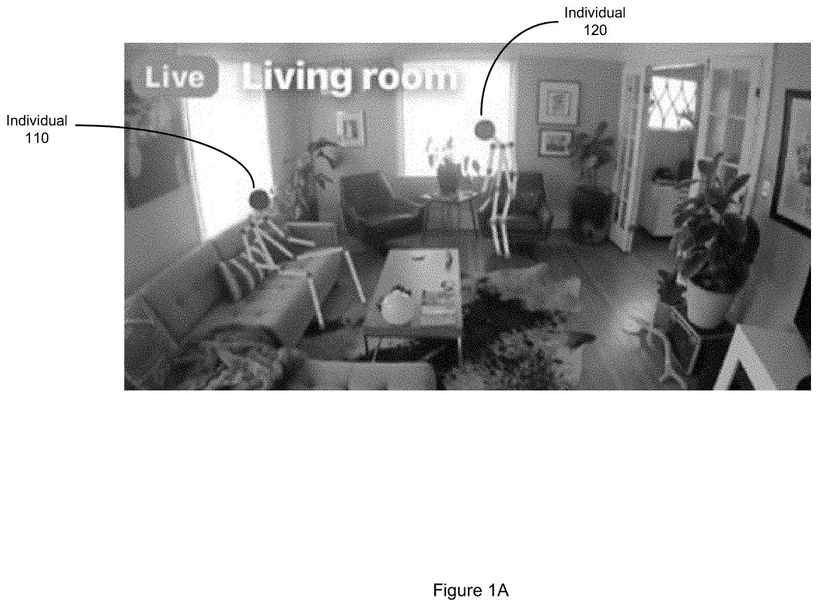

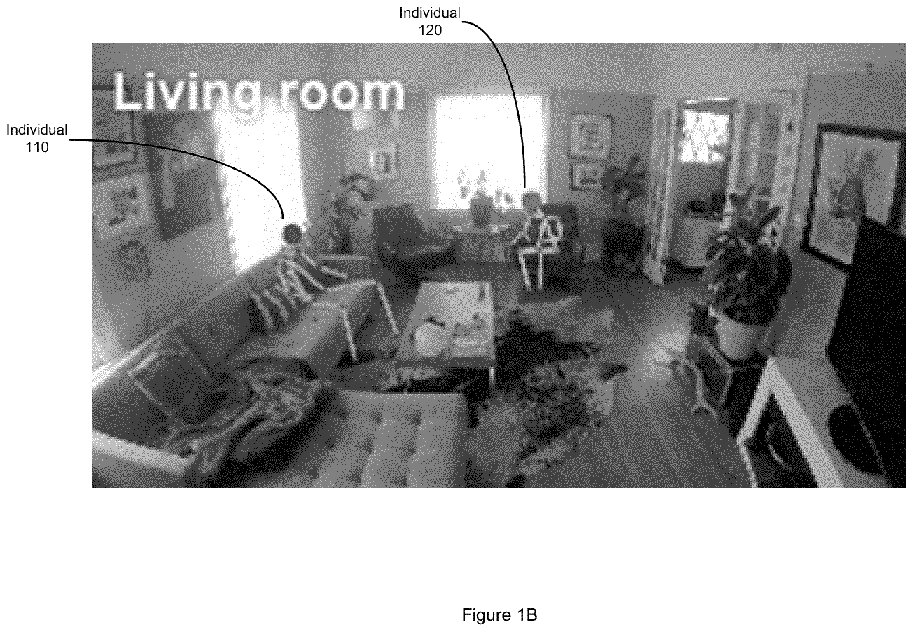

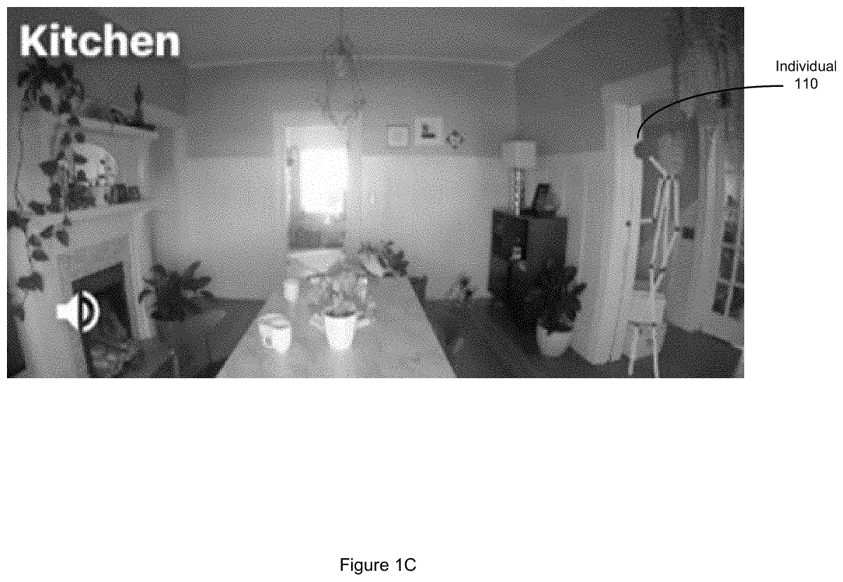

FIGS. 1A-1C depict an application example of a monitoring system in accordance with some embodiments. In this example, the monitoring system is monitoring a monitored location, e.g., living room, as illustrated in FIG. 1A. In this example, two individuals are present, individuals 110 and 120. The individuals are represented as a 2-D image for illustrative purposes. According to some embodiments, the identity of the individuals is obfuscated, e.g., by rendition in 2-D images, or pixelated, etc., in order to protect their privacy, e.g., in response to a privacy signal indication a desire to be in private mode. It is appreciated that in other embodiments, the individuals may be represented in as 2-D images in order to reduce the processing complexity and the processing resources of the computing system. In this illustrative example, individual 110 is seated while individual 120 is standing. Referring now to FIG. 1B, individual 120 is seated. Referring now to FIG. 1C, individual 110 is shown entering the kitchen area.

It is appreciated that the premises may be monitored in order to determine whether an abnormal activity has occurred. Moreover, it is appreciated that as more and more data, e.g., video/audio data, is collected and processed, the accuracy of the monitoring system in determining whether an abnormal activity has occurred increases.

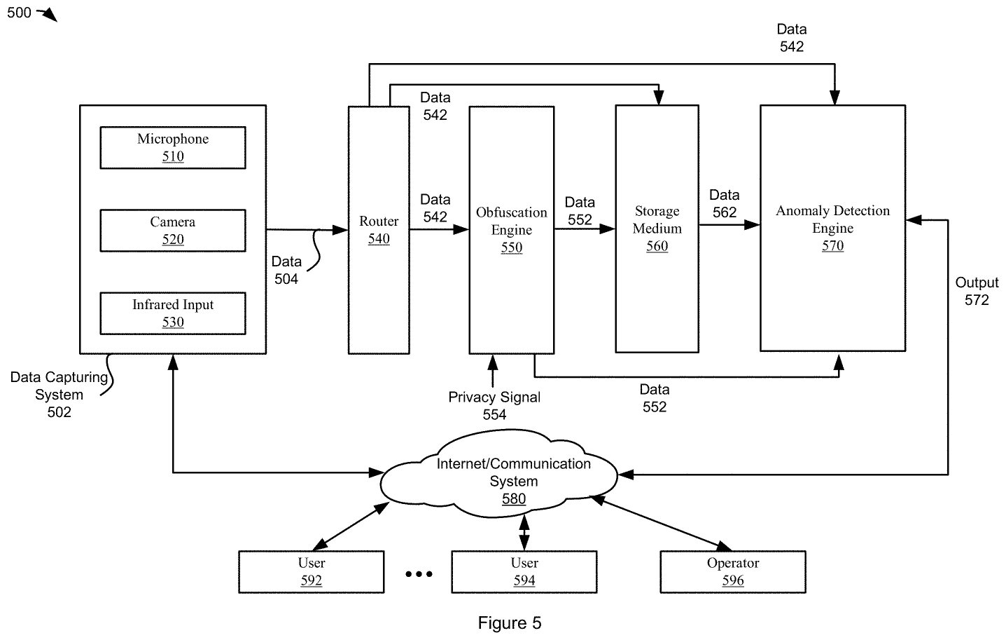

It is appreciated that monitored data (i.e. video data stream and audio data stream in this example) may be collected from one or more input devices (described in the monitoring system of FIG. 5). For example, one or more cameras may be used to capture images (e.g., still images or video stream). Similarly, one or more microphones (described in FIG. 5) may be used to capture audio data. In some embodiments, the captured data may be stored in a memory component (described in FIG. 5) while in other embodiments it may be modified, e.g., pixelated, 2-D image representation, etc., before storage. Whether the data is stored or not it is subsequently processed by a processing component (described in FIG. 5) that leverages one or more ML models. In this illustrative example, the data that has been collected is provided to the ML model to determine whether an abnormal activity/behavior has occurred in addition to refining the model over time, according to some embodiments.

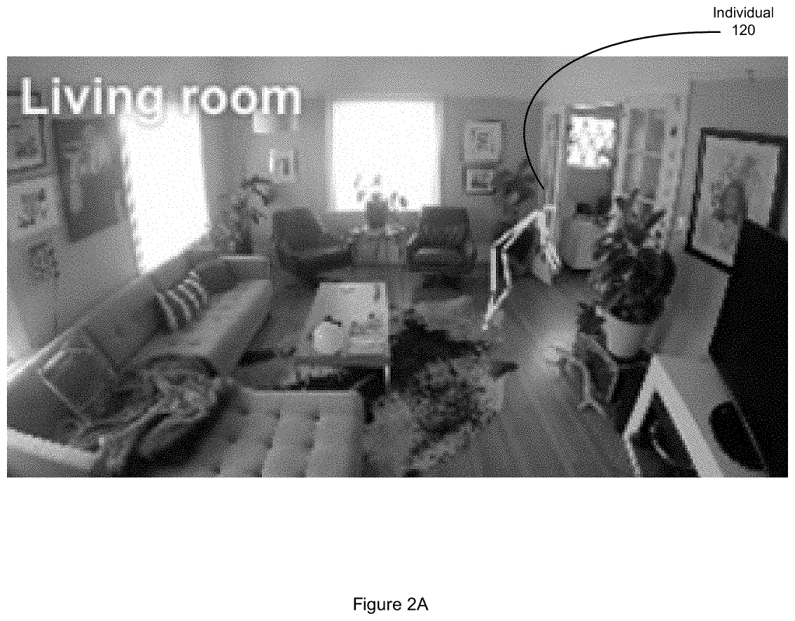

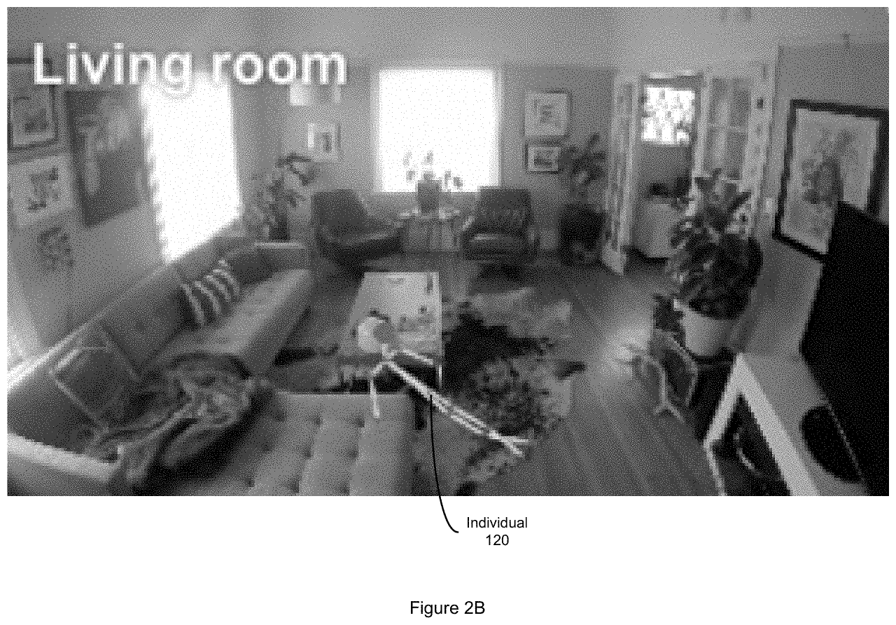

Referring now to FIGS. 2A-2B, an application example of a system detecting an abnormal activity in accordance with some embodiments is depicted. In FIG. 2A, individual 120 in the living room is monitored as the individual is about to trip over and fall. In some illustrative examples, this occurrence may be fed into the ML model (described in FIG. 5) that may determine that individual 120 rarely falls and that this tripping may be an onset of a more serious health condition. According to some embodiments, the ML model may use clustering/grouping in order to compare the instant occurrence to prior occurrences (i.e. past behavior of individual 120 or even behavior of other individuals). If the event and/or pattern thereof is consistent with the past behavior and/or occurrences/patterns then the behavior is determined to be normal otherwise it may be determined as abnormal activity or behavior. In this particular example, in FIG. 2B, individual 120 has fallen on the floor. As such, processing (described in FIG. 5) of the captured image determines the change in height from standing to being on the floor, change in pose (lying down), change in position (on the floor), change in body language and behavior (inability to move, etc.), change in facial features (e.g., left side of the face drooping, lips changing color to blue, etc.), etc. The captured images from FIG. 2B alone or in addition to prior image frame(s) from FIG. 2A once analyzed by a ML model (described in FIG. 5) may determine inconsistent behavior from the past behavior. In other words, the current activity (i.e. tripping and then falling) diverges from the past behavior (e.g., no past records of tripping and falling) that is considered as normal activity and behavior. As such, the ML model may generate an alert, e.g., a message, for an operator to escalate and seek help for the individual within the monitored premises. In some embodiments, the system may enable the operator to initiate a two way communication, e.g., voice call, video call, etc., with the individual 120. In yet other embodiments, the system may send a message to a family member notifying them of the abnormal activity.

It is appreciated that while in this particular example falling is identified as an abnormal activity or behavior in other examples it may not. For example, the same scenario of an individual tripping and falling may not be as alarming when a toddler is learning to walk in comparison to when an elderly person is tripping and falling. In other words, the ML model is tailored based on the individuals being monitored and as such it does not apply a one size fit all approach but rather tailors the processing based on the specifics associated with the premises being monitored and processed.

As yet another example, an individual with Alzheimer's that may need around the clock care may be monitored. Monitoring the premises and processing the captured data may reveal that the caretaker has left the premises and that the individual is alone. As such, based on the past behavior and knowledge by the ML model that this individual needs around the clock care, a determination is made that an abnormal activity/behavior has occurred. As such, an appropriate person such as an operator, care facility, family member, etc., may be notified via a messaging system. Accordingly, the operator, care facility, family member, etc., may escalate and take appropriate action.

It is appreciated that in some embodiments, the training data used to train the ML model may not be changed or modified over time based on the individual's behavior and/or activity within the monitored premises. As such, description of the ML model being modified over time based on the data being collected at the monitored location is for illustrative purposes and should not be construed as limiting the scope.

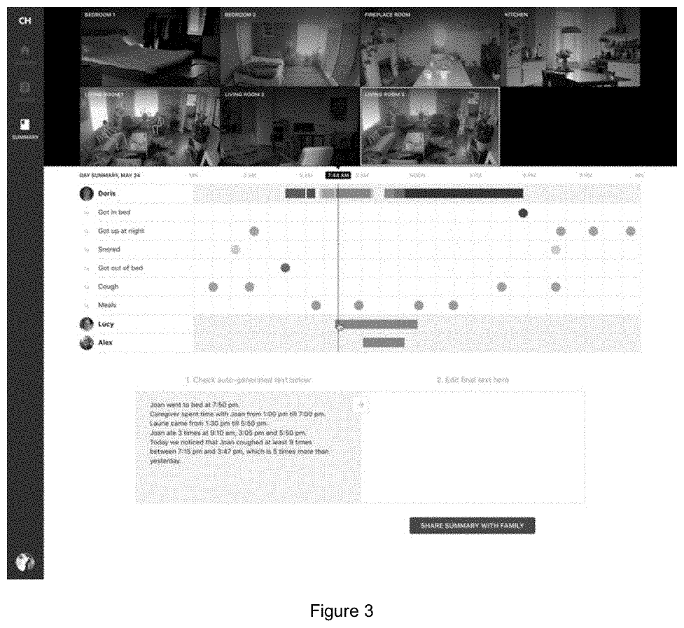

FIG. 3 depicts an application example of a monitoring system rendering events in accordance with some embodiments. The illustrated dashboard may display events throughout the day, weeks, months, etc. In this example, the monitored premises include two bedrooms, one fireplace room, one kitchen, and three living rooms. For each of the monitored location, e.g., kitchen, various events for each individual may be logged. For example, in this illustrative embodiment, Doris' activities have been monitored and logged, e.g., got in bed, got up at night, snored, got out of bed, cough, meals, etc. In some embodiments, the tracked activities may be dynamically changed by the user, operator, or family member. In some embodiments, the monitoring system (described in FIG. 5) may automatically modify the activities being tracked based on the individual's present and/or past behavior. For example, if an individual has never done a certain thing, e.g., stopped breathing at night while sleeping due to sleep apnea, then that occurrence may be tracked and logged. Similarly, individual's habits are also tracked, e.g., waking up in the morning on particular time during the week as opposed to weekends, etc. In other words, the monitoring may automatically determine what activity needs to be tracked and monitored and it automatically may make appropriate changes to what is to be tracked and what is to be ignored.

In this illustrative example, a number of times and the particular time during the day that an event has occurred may be tracked and displayed when requested. In this particular example, Doris has got up at night 4 times, at 7:45 pm, 9:30 pm, 11:30 pm, and 3:15 am. Similarly, number of times that Doris has snored and the time may be tracked and logged. It is appreciated that various activities are tracked for each individual at the monitored premises and may be displayed on the dashboard, when requested. The logged information may be provided to the processor that leverage ML models in order to determine an abnormal activity/behavior has occurred, as described above. It is appreciated that the activities that are monitored be nested activities (not shown). A nested activity may categories for the activities being tracked such that they are grouped based on category. In one nonlimiting example, a nested activity may be “bed” and other nested activities underneath that category may be “got in bed”, “got up at night”, “snored”, “got out of bed”, etc.

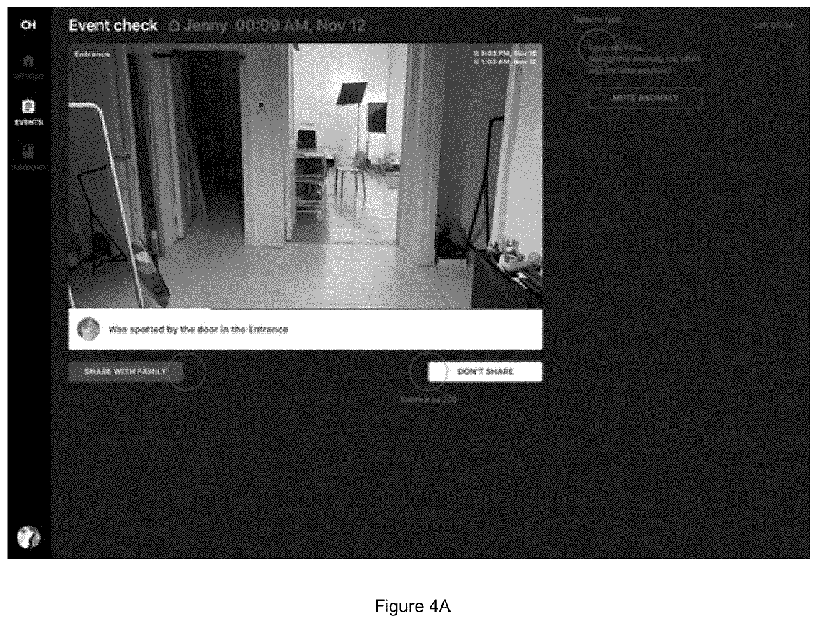

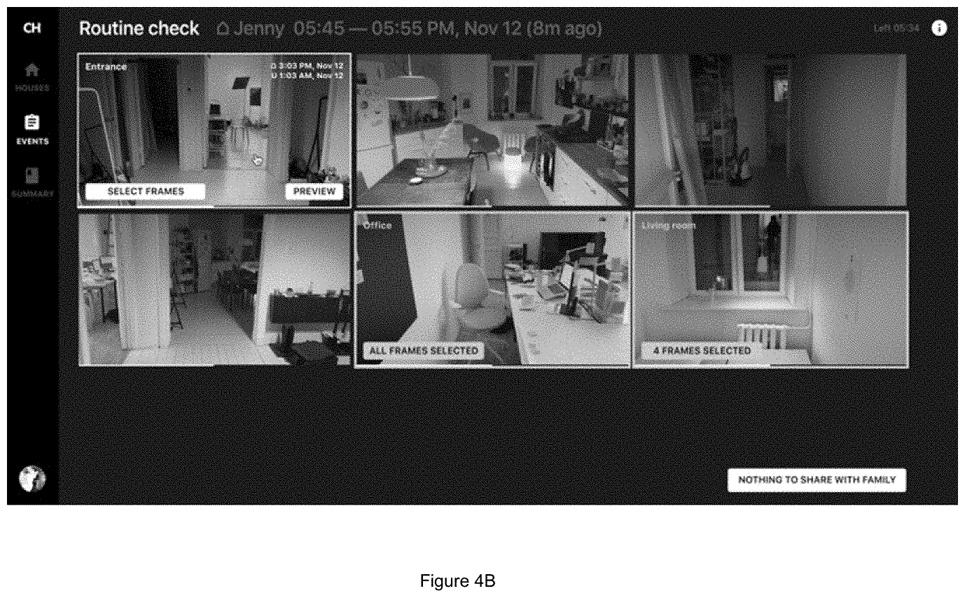

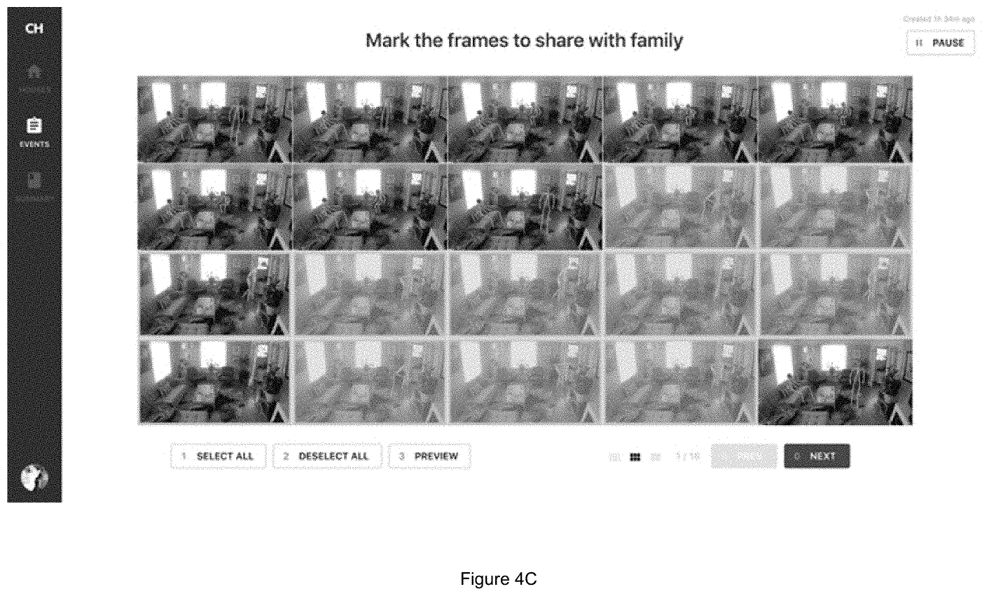

FIGS. 4A-4C depicts an application example of selecting a portion of the captured data to be transmitted for further analysis or for alerting an individual in accordance with some embodiments. Referring now to FIG. 4A, the processing unit (described in FIG. 5) leveraging one or more ML models may determine that an abnormal activity/behavior has occurred or that a determination could not be made that the activity/behavior was normal. In response, a collected video data stream or a portion thereof or a live video data stream may be transmitted for verification. In this example, the monitored individual was spotted by the door in the entrance that was deemed as abnormal. As such, the video data stream (e.g., collected video data stream, portion of the collected video data stream, or live data stream) may be transmitted to an operator or other users (e.g., family member) for verification. Referring now to FIG. 4B, the operator may select frames or portions thereof from various monitored locations, e.g., office, living room, and entrance, to be transmitted (described in FIG. 5) or for verification. It is appreciated that other frames from other monitored locations (on the premises) may remain unselected and therefore not transmitted. It is appreciated that selected frames from selected monitored locations may be transmitted to family members or a care facility, as shown in FIG. 4C. In this example, the frames associated with a monitored individual that seems to be hunching over a few times or bending at the waste is selected to be transmitted to a family member.

FIG. 5 depicts a block diagram of a monitoring system 500 in accordance with some embodiments. The system 500 includes a data capturing system 502 for collecting the monitoring data 504 that is transmitted to a router 540. The data capturing system 502 may include a microphone 510, a camera 520, an infrared input 530, or any other capturing device. The router 540 may process the received data 504 to generate data 542. The generated data 542 may be transmitted to the obfuscation engine 550 in order to obfuscate the individuals in the captured data, e.g., pixelating the individual, 2-D images, etc. In some embodiments, the router 540 transmits the data 542 to the storage medium 560, e.g., hard drive, solid state drive, etc., for storage. In yet other embodiments, the router 540 transmits the data 542 to the anomaly detection engine 570 for processing in order to determine body configuration, e.g., pose, position, facial features, orientation, height, etc., and to determine whether an abnormal activity/behavior has occurred based on the determined body configuration. It is appreciated that determining the body configuration by the anomaly detection engine 570 is for illustrative purposes and should not be construed as limiting the scope. For example, a separate processing unit may be used to determine the body configuration. In embodiments where the data is obfuscated by the obfuscation engine 550 to generate the obfuscated data 552. The obfuscation may occur in response to receiving a privacy signal 554 that is an indication that privacy is desired. In some embodiments, the obfuscation occurs in response to an indication that faster processing and/or limited processing resources are desired. The obfuscated data 552 may be transmitted to the storage medium 560 for storage and/or to the anomaly detection engine 570 for processing. It is appreciated that in some embodiments, the anomaly detection engine 570 receives the data to be processed from the storage medium 560, hence data 562 while in other embodiments it may receive data 542 and/or data 552 from other components for processing.

In some embodiments, the anomaly detection engine 570 applies one or more ML models (stored thereon) to the received data in order to determine whether an event is normal or abnormal. In some illustrative examples, the pose, facial features, positioning, orientation, height, etc., associated with a monitored individual is determined. Once the pose, facial features, positioning, orientation, height, etc., is determined it may be compared to past behavior/activity to determine whether an abnormal activity/behavior has occurred. In some embodiments, the determined pose, facial features, positioning, orientation, height, etc. may be compared to what is tagged as normal (e.g., normal with respect to other individuals and other premises). If the comparison matches within a certain acceptable threshold to the normal activity/behavior then it is determined that the activity/behavior is normal otherwise it is determined that an abnormal activity has occurred.

In some embodiments, the anomaly detection engine 570 may output 572 the result of the processing. The output 572 may be communicated to users 592, . . . , 594, and/or the operator 596 via the internet/communication system 580. As such, appropriate action may be taken as needed. For example, the operator 596 may further verify that indeed an abnormal activity/behavior has occurred or a user 592 (a family member) may determine that the monitored individual is in need of help and may initiate a call to 911 for help. In some embodiments, the communication may be established with the individual being monitored itself, as such communication through the data capturing system 502. In some embodiments, the communication with the individual being monitored may be through communicating to a device (separate from the data capturing system 502) associated with the individual being monitored, e.g., a cellular phone, a home phone, an email, etc.

It is appreciated that the components in the system 500 each runs on one or more computing units/appliances/devices/hosts (not shown) each with software instructions stored in a storage unit such as a non-volatile memory (also referred to as secondary memory) of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

For non-limiting examples, the anomaly detection engine 570 and/or the storage medium 560 and/or obfuscation engine 550 and/or router 540 and/or the data capturing system 502 or any portions thereof may be a computing device or be part of a computing device not limited to a server machine, a laptop PC, a desktop PC, a tablet, a Google's Android device, an iPhone, an iPad, and a voice-controlled speaker or controller. Each computing unit has a communication interface (not shown), which enables the computing units to communicate with each other, the user, and other devices over one or more communication networks following certain communication protocols, such as TCP/IP, http, https, ftp, and sftp protocols. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skilled in the art.

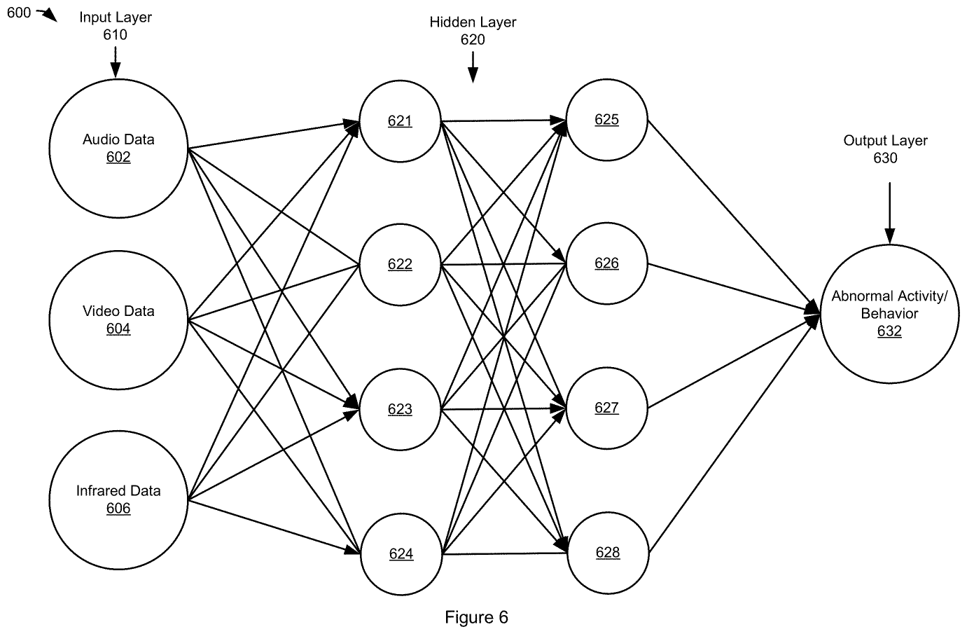

FIG. 6 depicts relational node diagram depicting an example of a neural network for identifying an abnormal activity in accordance with some embodiments. In an example embodiment, the neural network 600 utilizes an input layer 610, one or more hidden layers 620, and an output layer 630 to train the machine learning model(s) or model to identify an abnormal activity/behavior from a captured input data, e.g., audio data, video data, infrared data, etc. In some embodiments, where the abnormal activity/behavior, as described above, have already been confirmed, supervised learning is used such that known input data, a weighted matrix, and known output data are used to gradually adjust the model to accurately compute the already known output. Once the model is trained, field data is applied as input to the model and a predicted output is generated. In other embodiments, where the abnormal activity/behavior has not yet been confirmed, unstructured learning is used such that a model attempts to reconstruct known input data over time in order to learn. FIG. 6 is described as a structured learning model for depiction purposes and is not intended to be limiting.

Training of the neural network 600 using one or more training input matrices, a weight matrix, and one or more known outputs is initiated by one or more computers associated with the monitoring system. In an embodiment, a server may run known input data through a deep neural network in an attempt to compute a particular known output. For example, a server uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server computer then re-computes another output from the deep neural network with the input training matrix and the adjusted weight matrix. This process continues until the computer output matches the corresponding known output. The server computer then repeats this process for each training input dataset until a fully trained model is generated.

In the example of FIG. 6, the input layer 610 includes a plurality of training datasets that are stored as a plurality of training input matrices in a database associated with the monitoring system. The training input data includes, for example, audio data 602 from individuals being monitored, video data 604 from individuals being monitored, and infrared data 606 within the monitored premises and so forth. Any type of input data can be used to train the model.

In some embodiments, audio data 602 is used as one type of input data to train the model, which is described above. In some embodiments, video data 604 is also used as another type of input data to train the model, as described above. Moreover, in some embodiments, infrared data 606 is also used as another type of input data to train the model, as described above.

In some embodiments of FIG. 6, hidden layers 620 represent various computational nodes 621, 622, 623, 624, 625, 626, 627, 628. The lines between each node 621, 622, 623, 624, 625, 626, 627, 628 represent weighted relationships based on the weight matrix. As discussed above, the weight of each line is adjusted overtime as the model is trained. While the embodiment of FIG. 6 features two hidden layers 620, the number of hidden layers is not intended to be limiting. For example, one hidden layer, three hidden layers, ten hidden layers, or any other number of hidden layers may be used for a standard or deep neural network. The example of FIG. 6 also features an output layer 630 with the abnormal activity/behavior 632 as the known output. The appropriate abnormal activity/behavior 632 indicates the appropriate abnormal activity/behavior as opposed to a normal activity/behavior for a given monitoring system. For example, the appropriate abnormal activity/behavior 632 may be a certain event or occurrence based on the audio data 602, video data 604, and/or infrared data 606 as the input data. As discussed above, in this structured model, the appropriate abnormal activity/behavior 632 is used as a target output for continuously adjusting the weighted relationships of the model. When the model successfully outputs the appropriate abnormal activity/behavior 632, then the model has been trained and may be used to process live or field data.

Once the neural network 600 of FIG. 6 is trained, the trained model will accept field data at the input layer 610, such as audio data and video data and/or infrared data from the monitoring system. In some embodiments, the field data is live data that is accumulated in real time. In other embodiments, the field data may be current data that has been saved in an associated database. The trained model is applied to the field data in order to generate one or more abnormal activity/behavior at the output layer 630. Moreover, a trained model can determine that changing the model is appropriate as more data is processed and accumulated over time. Consequently, the trained model will determine the appropriate abnormal activity/behavior over time and based on a specific monitored area and tailored to the premises being monitored. It is appreciated that the derived models for each processing unit may be stored in the machine learning model module within the anomaly detection engine 570 for execution by the respective processing unit once live data is being received.

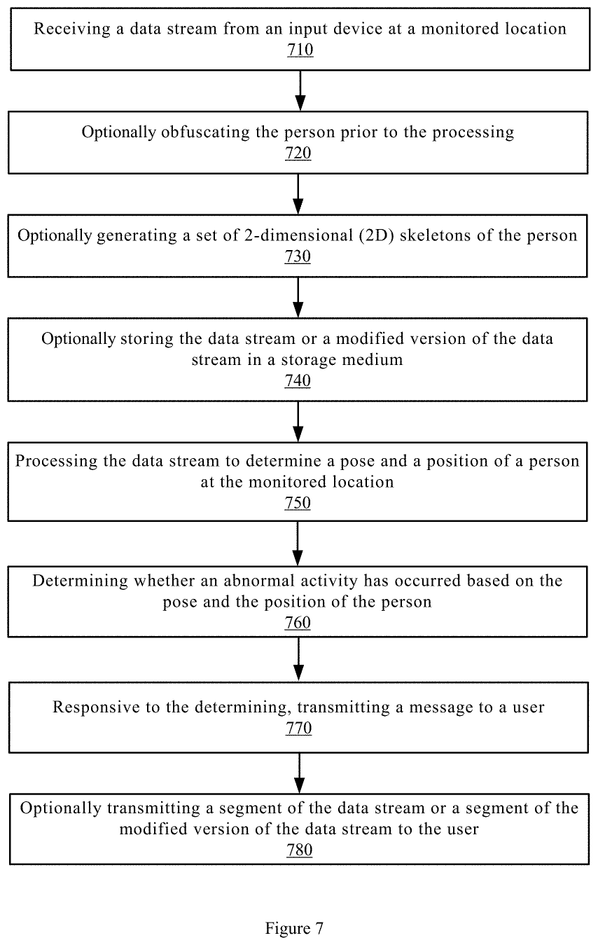

FIG. 7 depicts a flow chart illustrating an example of method flow for determining an abnormal activity in accordance with some embodiments. At step 710, a data stream, e.g., video stream, audio stream, infrared data, etc., from an input device at a monitored location is received, as described above. At step 720, the received data is optionally obfuscated. For example, the individual being monitored is pixelated. At step 730, a 2-D skeletons of the person is optionally generated from the received data stream. As such, the privacy of the individuals being monitored are protected or the processing speed is increased. At step 740, the received data stream or the modified version thereof is optionally stored in a storage medium. At step 750, the data stream or modified version thereof is processed to determine a pose, a position of the person at the monitored location. In some embodiments, the facial features of the person, the height of the person, the orientation of the person, etc., may be determined. At step 760, it is determined whether an abnormal activity has occurred based on the pose and position of the person. At step 770, in response to determining whether an abnormal activity has occurred, a message may be sent to a user, e.g., to the individual being monitored, to a family member, to an operator, to emergency center like 911, etc. The message may be a text message, or it may be any other type of communication, e.g., a call. In some embodiments, a two way communication between the operator and the individual being monitored is established. At step 780, a segment of the data stream or a modified version of it may optionally be transmitted to an operator for further verification.

It is appreciated that one embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

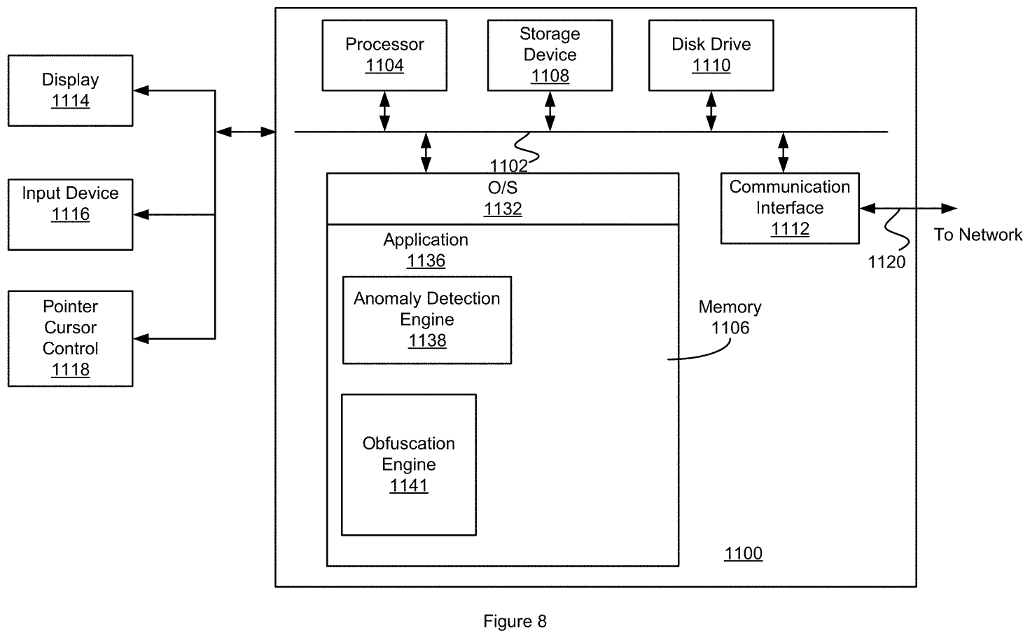

FIG. 8 depicts a block diagram depicting an example of computer system suitable for determining an abnormal activity in accordance with some embodiments. In some examples, computer system 1100 can be used to implement computer programs, applications, methods, processes, or other software to perform the above-described techniques and to realize the structures described herein. Computer system 1100 includes a bus 1102 or other communication mechanism for communicating information, which interconnects subsystems and devices, such as a processor 1104, a system memory (“memory”) 1106, a storage device 1108 (e.g., ROM), a disk drive 1110 (e.g., magnetic or optical), a communication interface 1112 (e.g., modem or Ethernet card), a display 1114 (e.g., CRT or LCD), an input device 1116 (e.g., keyboard), and a pointer cursor control 1118 (e.g., mouse or trackball). In one embodiment, pointer cursor control 1118 invokes one or more commands that, at least in part, modify the rules stored, for example in memory 1106, to define the electronic message preview process.

According to some examples, computer system 1100 performs specific operations in which processor 1104 executes one or more sequences of one or more instructions stored in system memory 1106. Such instructions can be read into system memory 1106 from another computer readable medium, such as static storage device 1108 or disk drive 1110. In some examples, hard-wired circuitry can be used in place of or in combination with software instructions for implementation. In the example shown, system memory 1106 includes modules of executable instructions for implementing an operating system (“OS”) 1132, an application 1136 (e.g., a host, server, web services-based, distributed (i.e., enterprise) application programming interface (“API”), program, procedure or others). Further, application 1136 includes a module of executable instructions for anomaly detection engine 1138 that determines whether an abnormal activity/behavior has occurred and an obfuscation engine 1141 to obfuscate the received data stream, e.g., pixelate the individuals being monitored, generate a 2-D image of the individuals being monitored, etc.

The term “computer readable medium” refers, at least in one embodiment, to any medium that participates in providing instructions to processor 1104 for execution. Such a medium can take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1100. According to some examples, two or more computer systems 1100 coupled by communication link 1120 (e.g., LAN, PSTN, or wireless network) can perform the sequence of instructions in coordination with one another. Computer system 1100 can transmit and receive messages, data, and instructions, including program code (i.e., application code) through communication link 1120 and communication interface 1112. Received program code can be executed by processor 1104 as it is received, and/or stored in disk drive 1110, or other non-volatile storage for later execution. In one embodiment, system 1100 is implemented as a hand-held device. But in other embodiments, system 1100 can be implemented as a personal computer (i.e., a desktop computer) or any other computing device. In at least one embodiment, any of the above-described delivery systems can be implemented as a single system 1100 or can implemented in a distributed architecture including multiple systems 1100.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A method comprising:
receiving a data stream from an input device at a monitored location;
processing the data stream to determine a pose and a position of a person at the monitored location;
determining whether an abnormal activity has occurred based on the pose and the position of the person; and
responsive to the determining, transmitting a message to a user.

2. The method of claim 1, wherein the user is a same as the person at the monitored location.

3. The method of claim 1, wherein the data stream includes a video stream and audio stream.

4. The method of claim 3, wherein the method further comprises obfuscating the person prior to the processing.

5. The method of claim 4, wherein the obfuscation includes generating a set of 2-dimensional (2D) skeletons of the person.

6. The method of claim 1, wherein the processing the data stream further determines orientation and a height of the person with respect to a floor.

7. The method of claim 1, wherein the user is a person different from the person at the monitored location.

8. The method of claim 1, wherein the determining whether abnormal activity has occurred includes applying a machine learning model that compares the pose and the position to prior poses and positions captured over a period of time.

9. The method of claim 8, wherein the machine learning model is trained based on the prior poses and positions.

10. The method of claim 8, wherein the machine learning model includes clustering and grouping model.

11. The method of claim 1, wherein the input device includes a camera and a microphone.

12. The method of claim 1 further comprising storing the data stream or a modified version of the data stream in a storage medium.

13. The method of claim 1 further comprising transmitting a segment of the data stream or a segment of the modified version of the data stream to the user.

14. The method of claim 13, wherein the user is an operator, and wherein the message requests a verification from the operator whether the abnormal activity has occurred based on the segment of the data stream or the segment of the modifier version of the data stream.

15. The method of claim 1, wherein the determining whether the abnormal activity has occurred is further based on audio analysis.

16. A method comprising:
receiving a video/audio data stream from an input device at a monitored location;
processing the video/audio data stream to determine a body configuration associated with a person at the monitored location;
applying a machine learning model to the body configuration to compare the body configuration to prior body configurations, wherein the applying determines whether an abnormal activity has occurred; and
responsive to determining that the abnormal activity has occurred, transmitting a message to a user.

17. The method of claim 16, wherein the user is a same as the person at the monitored location, and wherein the message is a textual or audio communication with the person.

18. The method of claim 16, wherein the user is an operator and wherein the message is to initiate an emergency communication.

19. The method of claim 16 further comprising obfuscating the person in response to receiving a privacy signal.

20. The method of claim 16 further comprising generating a set of 2-dimensional (2D) skeletons of the person in the received video/audio data stream.

21. The method of claim 16 further comprising pixelating the person to coverup facial features of the person.

22. The method of claim 16, wherein the body configuration includes body pose, body position, body orientation and height with respect to a floor.

23. The method of claim 16 further comprising transmitting a segment of the video/audio data stream or a segment of the modified version of the video/audio data stream to an operator when applying the machine learning model is insufficient in determining whether the abnormal activity has occurred, and wherein the transmitting further includes another message to the operator to review to transmitted data stream and determine whether the abnormal activity has occurred.

24. The method of claim 16, wherein the machine learning model is neural network model and includes clustering and grouping model.

25. The method of claim 16, wherein the input device includes a camera and a microphone.

26. The method of claim 16 further comprising training the machine learning model over time based on additional processed video/audio data stream.

27. The method of claim 16, wherein the applying further includes applying the machine learning model to the audio data stream to compare the audio data stream to parse out whether the abnormal activity has occurred.

28. The method of claim 27, wherein the applying the machine learning model to the audio data stream includes a natural language processing.

29. A system comprising:
a data capturing system configured to capture a video/audio data at a monitored location;
a processing unit configured to receive the video/audio data and determine a body configuration associated with a person at the monitored location, wherein the processing unit is further configured to apply a machine learning model to the body configuration to compare the body configuration to prior body configurations and to determine whether an abnormal activity has occurred; and
a transmitter configured to transmitting a message to a user in response to determining that the abnormal activity has occurred.

30. The system of claim 29 further comprising an obfuscation engine configured to obfuscate the person in the captured video/audio data.

31. The system of claim 30, wherein the obfuscation engine generates a set of 2-dimensional (2D) skeletons of the person in the received video/audio data stream or pixelates the person in the received video/audio data stream.

32. The system of claim 29, wherein the body configuration includes body pose, body position, body orientation and height with respect to a floor.

33. The system of claim 29, wherein the transmitter is configured to transmit a segment of the video/audio data stream or a segment of a modified version of the video/audio data stream to an operator when applying the machine learning model is insufficient in determining whether the abnormal activity has occurred, and wherein the transmitting further includes another message to the operator to review to transmitted data stream and determine whether the abnormal activity has occurred.

34. The system of claim 29, wherein the machine learning model is neural network model and includes clustering and grouping model.

35. The system of claim 29, wherein the data capturing system includes a camera and a microphone.
